(19) United States
(12) Patent Application Publication
(10) Pub. No.: US 2007/0245206 A1
(43) Pub. Date: Oct. 18, 2007

(54) Method for Transmitting a Radio Navigation Signal

(76) Inventors: Nicolas Martin, Bourg Les Valence (FR); Valery Leblond, Valence (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/628,864

(22) PCT Filed: May 27, 2005
(86) PCT No.: PCT/EP05/52420

§ 371 Date: Dec. 8, 2006

(30) Foreign Application Priority Data
Jun. 8, 2004 (FR) 04 06186

(51) Int. Cl. G01S 1/00

(52) U.S. Cl. 714/752

(57) ABSTRACT

The invention relates to a method of transmitting a radionavigation signal which comprises coded and interleaved data; the signal comprises a pathway modulated by the coded and interleaved data and another pathway not modulated by these data, and the pathway not modulated by these data comprises a known code Cp making it possible to synchronize on reception the deinterleaving of the interleaved data.

### CROSS-REFERENCE TO RELATED APPLICATIONS

The present application is based on International Application No. PCT/EP2005/052420, filed on May 27, 2005, which in turn corresponds to France Application No. 04 06186 filed Jun. 8, 2004, and priority is hereby claimed under 35 USC §119 based on these applications. Each of these applications are hereby incorporated by reference in their entirety into the present application.

### FILED OF THE INVENTION

The invention relates to the transmission of a radionavigation signal.

### BACKGROUND OF THE INVENTION

Satellite-based radionavigation makes it possible to obtain the position of a receiver from signals transmitted by satellites.

In current radionavigation systems such as the GPS system (acronym standing for the expression “Global Positioning System”) or GLONASS system, the satellites transmit a signal consisting of a carrier modulated by a known spreading code, at high frequency (a few MHz), and by data unknown a priori, at low frequency (50 Hz typically).

Generally, current or future satellite-based radionavigation systems are denoted GNSS systems (acronym standing for the expression “Global Navigation Satellite System”).

For reasons of robustness and integrity of the restitution of the data received, future navigation systems such as the GALILEO system, will use techniques for coding the data on transmission making it possible to detect and to automatically correct errors on reception.

A known technique consists in using on transmission a convolutional coding using shift registers and introducing a redundancy, and on reception a decoding based on the Viterbi algorithm.

This technique is generally associated on transmission, with an interleaving of the previously coded data bits and on reception with a deinterleaving of the received data, before their decoding.

This makes it possible to process the consecutive bit errors due to a disturbance in the transmission channel between the antenna of the transmitter and that of the receiver, by dispersing the erroneous bits and by reconstituting them by redundancy.

But deinterleaving is not a time-invariant process and it requires a synchronization when the deinterleaving starts. The data bits make it possible to effect this synchronization but in the case of certain interleavings, the data bits cannot be used since they are accessible only after deinterleaving and decoding.

One solution consists in trying several synchronization hypotheses in parallel or sequentially, performing the deinterleaving and the decoding for each until the convergence of the process, that is to say until the bit error rate (which is an indicator of the Viterbi algorithm) is low. This mobilizes a significant calculation load and complicates the architecture of the receiver.

Another solution has been proposed in the case of the Galileo system. It consists in inserting into the stream of data bits, sequences of bits that are recognizable, not coded or interleaved, and denoted by the expression “Unique Word Insertion”. This makes it possible to directly synchronize the deinterleaving of the bits received between the sequences. The drawback of this solution is that it reduces the useful throughput since the synchronization bits do not contain information and that moreover it makes it necessary to interrupt the process for interleaving the symbols thereby complicating it.

A significant aim of the invention is therefore to synchronize the deinterleaving without encountering the above-mentioned drawbacks.

### SUMMARY OF THE INVENTION

To achieve this aim, the invention proposes a method of transmitting a radionavigation signal which comprises coded and interleaved data, principally characterized in that the signal comprises a pathway modulated by the coded and interleaved data and another pathway not modulated by these data, and in that the pathway not modulated by these data comprises a known code Cp making it possible to synchronize on reception the deinterleaving of the interleaved data.

Thus on reception, this code of the pilot pathway is used to effect the synchronization without having to deinterleave and to decode the unknown data of the data pathway and without reducing the useful throughput.

According to a characteristic of the invention, the interleaving and the deinterleaving are obtained on the basis of a memory comprising rows and columns exhibiting respectively M and N memory slots.

The interleaving is for example convolutional with N=M and the known code Cp exhibits a length which is a multiple of M.

The interleaving can also be a matrix interleaving and the known code Cp exhibits a length which is a multiple of M.N.

According to a characteristic of the invention, the data are coded by using an error correcting code, for example an “FEC” code.

Preferably, the pathway not modulated by the data furthermore comprises a primary code, the known code Cp then being denoted secondary code Csp.

The invention is also aimed at a transmitter of a radionavigation signal comprising a data generator, a device for coding the data, a device for interleaving the coded data, characterized in that it comprises a generator of code Cd intended to generate a signal modulated by the coded and interleaved data and a generator of code Cp decorrelated from the code Cp and intended to generate a signal not modulated by these data.

According to a characteristic of the invention, the so-called convolutional interleaving device comprises a memory which comprises rows and columns each exhibiting M memory slots, and the generator of code Cp is intended to generate a code of length equal to a multiple of M.

According to another characteristic of the invention, the so-called matrix interleaving device comprises a memory which comprises rows and columns exhibiting respectively M and N memory slots and the generator of code Cp is intended to generate a code of length equal to a multiple of M.N.

The invention also relates to a receiver of at least one radionavigation signal comprising coded and interleaved data modulated by a code Cd, the receiver being equipped with a reception channel for each radionavigation signal, and comprising for at least one reception channel, a generator of the code able to demodulate the radionavigation signal so as to obtain the coded and interleaved data, a device for deinterleaving the coded data, characterized in that the reception channel comprising two pathways, the deinterleaving device is on a first pathway and in that it comprises on the second pathway, a generator of another code Cp decorrelated from the code Cd, and intended to synchronize the deinterleaving device.

### BRIEF DESCRIPTION OF THE DRAWINGS

Other characteristics and advantages of the invention will appear on reading the detailed description which follows, given by way of nonlimiting example and with reference to the appended drawings in which:

FIG. 1a diagrammatically represents an exemplary data coder, based on the use of 6 shift registers; in FIG. 1b are represented the data bits before coding and the symbols D_{cod}(t) obtained after coding, according to the example of FIG. 1a,

FIG. 2a diagrammatically represents an example of symbols D_{cod}, at the input of an interleaving device, and the interleaved symbols Dₑₙₜ(t), intended to be transmitted; exemplary arrangements of memory slots making it possible to obtain a convolutional or matrix interleaving are respectively represented in FIGS. 2b and 2c,

FIG. 3 diagrammatically represents the main components of a known transmitter based on the use of an error correcting code and of an interleaving,

FIG. 4 diagrammatically represents examples of signals used for transmission,

FIG. 5 diagrammatically represents an exemplary known receiver comprising a decoding device and a deinterleaving device,

FIG. 6 diagrammatically represents an exemplary integration interval, exemplary arrangements of memory slots making it possible to obtain a deinterleaving corresponding to the convolutional interleaving of the transmission is represented in FIG. 7a; in FIG. 7b are represented examples of interleaved symbols Dₑₙₜ, and the deinterleaved symbols D_{cod}(t), respectively at the input and at the output of the deinterleaving device,

FIG. 8 diagrammatically represents the main components of a transmitter according to the invention,

FIG. 9 diagrammatically represents an exemplary receiver according to the invention,

FIG. 10 diagrammatically represents an exemplary product code produced from a primary code Cₚₚ and from a secondary code Cₚₚ,

FIG. 11a diagrammatically represents an exemplary signal of the pilot pathway which comprises a secondary code Cₛₚ(t); FIG. 11b diagrammatically represents an example of interleaved symbols Dₑₙₜ of the data pathway, at the input of the deinterleaving device; FIG. 11c illustrates an exemplary convolutional deinterleaving.

### DETAILED DESCRIPTION OF ILLUSTRATIVE EMBODIMENTS

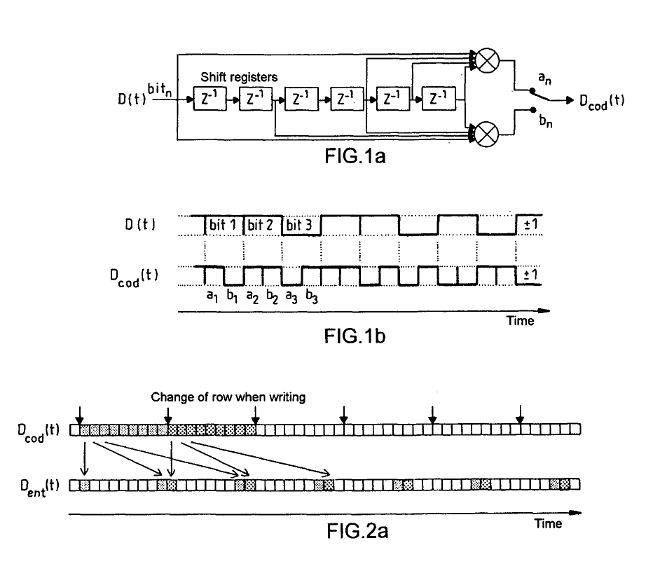

Illustrated in FIG. 1a is an exemplary data coder, based on the use of 6 shift registers, that is to say on the use of 7 consecutive bits, bitₙ, bitₙ₋₁, . . . , bitₙ₋₆. The data D(t) are presented in the form of bits at the input of the coder according to a throughput d. At the output, the coder provides the coded data in the form of symbols aₙ(t) and bₙ(t) according to a throughput 2d.

In this example, we obtain:
aₙ=bitₙ×bitₙ₋₄×bitₙ₋₅×bitₙ₋₆
bₙ=bitₙ×bitₙ₋₂×bitₙ₋₄×bitₙ₋₆

In FIG. 1b are represented the data bits D(t) before coding and the symbols D_{cod}(t) obtained after coding, according to the example of FIG. 1a. We have:
D_{cod}(t)=a₁, b₁ a₂ b₂ . . . aₙ bₙ

The symbols D_{cod}(t) obtained at the output of the coder are thereafter interleaved according to a convolutional or matrix or other mode.

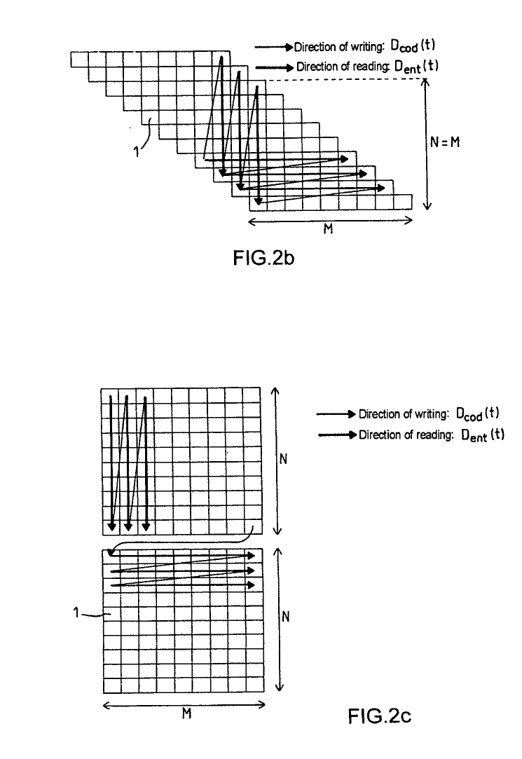

We shall describe an exemplary convolutional interleaving. In FIG. 2a are represented the symbols D_{cod}, at the input of the interleaving device, and the interleaved symbols Dₑₙₜ(t), intended to be transmitted. The interleaving device comprises memory slots arranged as an array: at the input, the symbols are written row-wise and, at the output the symbols are read column-wise, thereby producing the interleaving. The changes of row have been indicated in FIG. 2a.

According to the arrangement of these memory slots, the interleaving obtained is convolutional or matrix or other.

Exemplary arrangements of memory slots 1 making it possible to obtain a convolutional or matrix interleaving are respectively represented in FIGS. 2b and 2c. The directions of writing of the symbols in order (at input, i.e. D_{cod}(t)) and of reading (at output, or Dₑₙₜ(t)) of the interleaved symbols are indicated.

The interleaved symbols Dₑₙₜ are thereafter modulated in a conventional manner by a spreading code and a carrier before being transmitted.

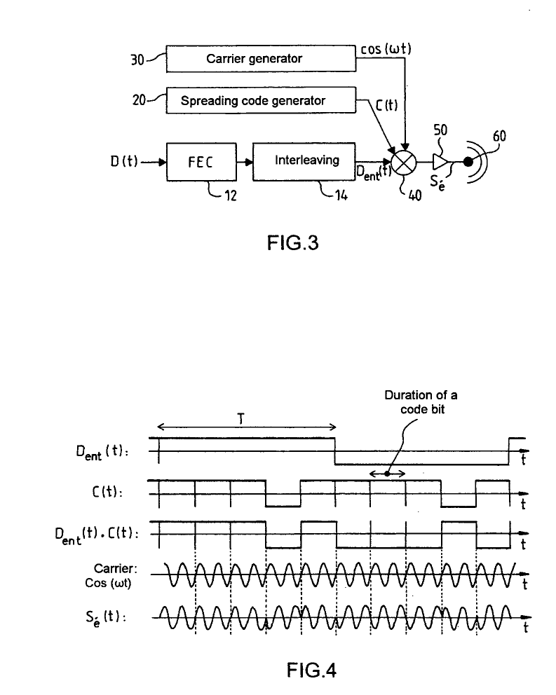

The main components of a known transmitter based on the use of an error correcting code and of an interleaving have been represented in FIG. 3. It comprises a device 12 for coding by an error correcting code (“FEC” acronym standing for the expression “Forward Corrector Error”) and an interleaving device 14, a spreading code generator 20, a carrier generator 30, a modulator 40, an amplifier 50 of coefficient A and a transmission antenna 60.

Examples of signals used for transmission have been represented in FIG. 4: the interleaved symbols Dₑₙₜ(t), the spreading code C(t), the signal Dₑₙₜ(t).C(t) obtained, the carrier cos(ωt) and the signal transmitted Sₑ(t) which is of the form,
Sₑ(t)=A. cos (ωt). C(t).Dₑₙₜ(t)

The duration T of a data symbol Dₑₙₜ(t) is that of a periodic code sequence.

On reception, the received signal Sᵣ(t) is of the form:
Sᵣ(t)=Sₑ(t)+S_{disturbances}(t)
With S_{disturbances}=noise+other signals.

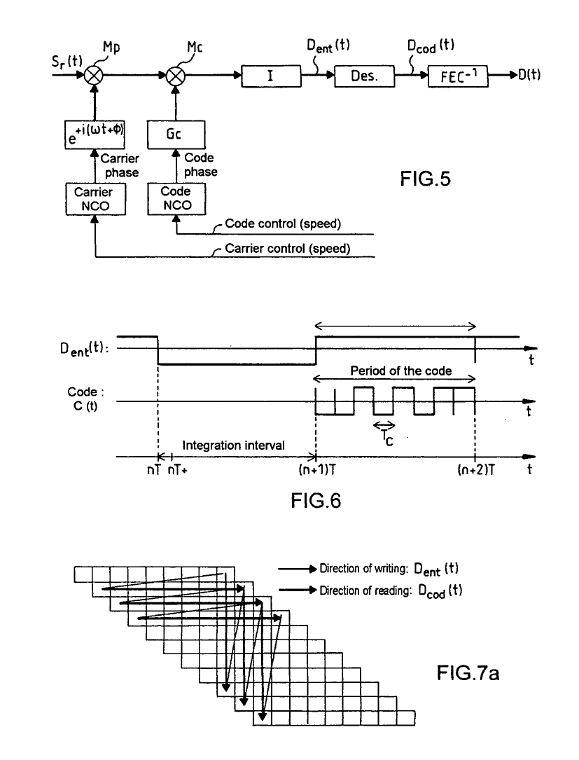

An exemplary known receiver is represented in FIG. 5. A complex multiplier Mp makes it possible to eliminate the carrier by multiplying the signal sampled by the complex signal e^{j(ωt+φ)} arising from a feedback-control loop for slaving the carrier which in particular comprises in a conventional manner a carrier generator (cosine and sine table) and an NCO integrator (the acronym standing for the expression “Numerically Controlled Oscillator”). The signal obtained is then correlated with a local primary code by means of a complex multiplier Mc (or more than one), each complex multiplier being associated with a complex integrator I. The local code, a replica of the code transmitted, arises from a code feedback-control loop which in particular comprises a generator Gc of local code and an NCO integrator.

We recall that NCO integrators provide on the basis of the speed commands updated by the loop for feedback control at a frequency of less than 1 KHz, the phase of the carrier or of the code produced at the sampling frequency, i.e. a few MHz.

At the output of the integrator I, we obtain the signal z:
z(n)=1/T∫_{[nT, (n+1)T]}S_{received}(t).e^{j(ωt+φ)}.C(t+τ) dt

The integration interval corresponds to the duration of a data symbol as illustrated in FIG. 6.

We furthermore assume that the local code C(t+τ) has been synchronized with the code received C(t) in the course of a first acquisition phase, that is to τ=0.

By replacing S_{received} by Sₑ+S_{disturbances}, we obtain for z:
z(n)=1/T∫_{[nT, (n+1)T]}Sₑ(t).e^{j(ω+φ)}. C(t)dt (1)
+1/T∫_{(nT, (n+1)T]}S_{disturbances}(t).e^{j(ω+φ)}.C(t)dt (2)
(1)=1/T∫_{[nT, (n+1)T]}A. cos(ωt). C(t).Dₑₙₜ(t).e^{j(ωt+φ)}.C(t)dt
(2)=noise

Concerning the term (1), we have: C(t).C(t)=1

Denoting by nT₊ the value following the transition nT (cf. FIG. 6), we finally obtain:
z(n)=½A e^{jφ}Dₑₙₜ(nT₊)+noise

We have thus eliminated the modulation by the carrier and by the spreading code. By virtue of a carrier phase loop (“PLL” acronym standing for the expression “Phase Lock Loop”), the phase of the local carrier φ is slaved with respect to that of the carrier received, equal to 0. The modulation is finally preserved by the interleaved coded data Dent.

The latter are then deinterleaved by means of a deinterleaving device Des to obtain the coded symbols Dcod(t). The deinterleaving must correspond to the interleaving.

Exemplary arrangements of memory slots making it possible to obtain a deinterleaving corresponding to the interleaving of the transmission is represented in FIG. 7a. It involves a convolutional deinterleaving. The memory slots are arranged in an array which has the same form as for the interleaving but the directions of writing (at input) of the interleaved symbols and of reading (at output) of the symbols in order are inverted with respect to the directions of writing and of reading adopted on transmission. In FIG. 7b are represented the interleaved symbols Dₑₙₜ, at the input of the deinterleaving device, and the deinterleaved symbols D_{cod}(t), intended to be decoded. The changes of column have been indicated in FIG. 7b.

The coded symbols D_{cod}(t) obtained are then decoded by means of a device for implementing the Viterbi algorithm, “FEC⁻¹” to obtain the data D(t).

But deinterleaving is not a time-invariant process and it therefore requires a synchronization when the deinterleaving starts so as to determine the instants of changes of column at the input of the deinterleaving device.

The method according to the invention consists in using a radionavigation signal comprising two pathways, one called the data pathway, the other the pilot pathway, and in using this pilot pathway to synchronize the deinterleaving on reception:

the data pathway corresponds to the traditional signal consisting of a carrier modulated by a known spreading code C_{d}(t) and by data unknown a priori,

the pilot pathway is a signal produced like the traditional signal consisting of a carrier of the same frequency as that of the data pathway, modulated by a known spreading code Cₚ(t) but not modulated by unknown data. The code Cₚ(t) comprises a sequence of data that are known in advance which is used on reception to allow direct synchronization; it is furthermore decorrelated from the code C_{d}(t). We generally choose a code whose period is long. This makes it possible to decrease the cross-correlations between the codes from one satellite to the other and therefore to better differentiate between the satellites. This furthermore presents the advantage of better combatting of narrowband interference.

On reception, this code of the pilot pathway is used to effect the synchronization without having to deinterleave and to decode the unknown data of the data pathway.

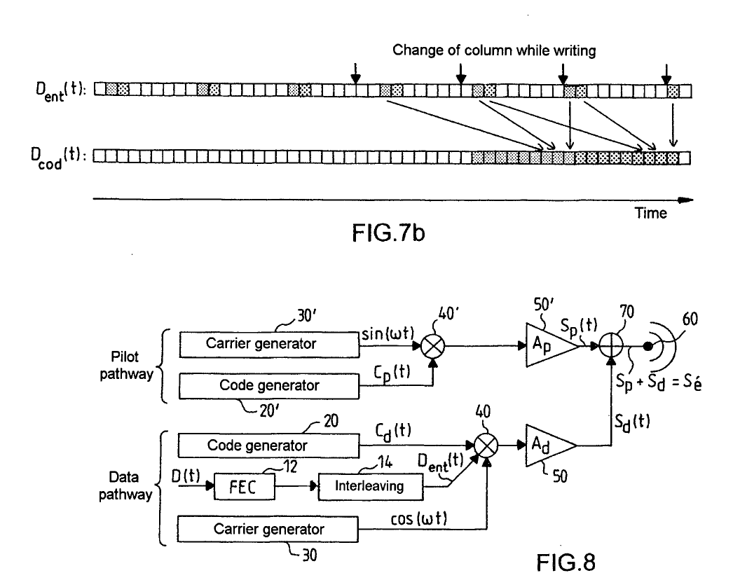

Represented in FIG. 8 are the main components of a transmitter according to the invention based on the use of an error correcting code, of an interleaving and on the use of two pathways, a pilot pathway and a data pathway. It comprises for the data pathway, a coder comprising a device for coding by an error correcting code 12 and an interleaving device 14, a generator of spreading code Cd 20, a carrier generator 30, a modulator 40, an amplifier 50 of coefficient A_{d}, which produce a data signal S_{d}(t); it comprises for the pilot pathway a generator of spreading code Cp 20′, a carrier generator 30′, a modulator 40′, an amplifier 50′ of coefficient Aₚ which produce a pilot signal Sₚ(t). It furthermore comprises a summator 70 which makes it possible to perform a summation of these signals Sp+Sd and a transmission antenna 60.

The signal transmitted Sₑ(t) is of the form:
Sₑ(t)=S_{d}(t)+Sₚ(t) with
S_{d}(t)=A_{d}. cos(ωt). C_{d}(t).Dₑₙₜ(t)
Sₚ(t)=Aₚ. sin(ωt).Cₚ(t).

The pilot and data pathways are in carrier phase quadrature by way of example. This makes it possible to retain an envelope that is constant at the level of the energy of the signal transmitted.

Hereinafter, for simplicity the particular case where Aₚ=A_{d}=1 will be considered.

On reception, the received signal Sᵣ(t) is of the form:
Sᵣ(t)=Sₑ(t)+S_{disturbances}(t)
With S_{disturbances}=noise+other signals.

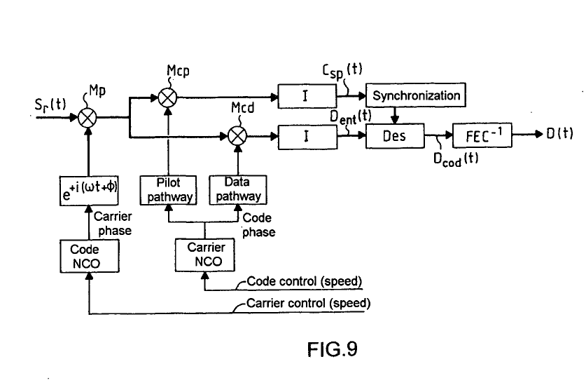

An exemplary receiver according to the invention is represented in 35 FIG. 9. A complex multiplier Mp then makes it possible to eliminate the carrier by multiplying the signal sampled by the complex signal e^{j(ω+φ)} arising from a feedback-control loop for slaving the carrier which in particular comprises in a conventional manner a carrier generator (cosine and sine table) and an NCO integrator (acronym standing for the expression “Numerically Controlled Oscillator”). The signal obtained is then correlated on the one hand with a local code of the pilot pathway, and on the other hand with a local code of the data pathway, by means of a complex multiplier (or more than one) per pathway, each complex multiplier being associated with a complex integrator I; the multipliers are respectively denoted Mcp and Mcd. For each pathway, each of the signals obtained is integrated by intervals by means of the integrators I. The local codes respectively arise from a code feedback-control loop which in particular comprises a generator Gcp of local code for the pilot pathway, a generator Gcd of local code for the data pathway and an NCO integrator.

At the output of the integrators I, we obtain the signal zₚ for the pilot pathway and the signal z_{d} for the data pathway:
zₚ(n)=1/T∫_{[nT, (n+1)T]}S_{received}(t).e^{j(ω+φ)}.Cₚ(t+τ)dt
z_{d}(n)=1/T∫_{[nT, (n+1)T]}S_{received}(t).e^{j(ω+φ)}.C_{d}(t+τ)dt

Replacing S_{received} by Sₚ+S_{d}+S_{disturbances}, and also assuming that the local code (pilot respectively data) has been synchronized with the code received (pilot respectively data) in the course of a first acquisition phase, we obtain for z_{d}:

$$\begin{matrix}{z}_{d} ( n ) = 1 / T \int [ nT , ( n + 1 ) T ] {S}_{p} ( t ) \cdot {ⅇ}^{j ( ω t + ϕ )} \cdot {C}_{d} ( t ) ⅆ t & ( 1 ) \\ + 1 / T \int [ nT , ( n + 1 ) T ] {S}_{d} ( t ) \cdot {ⅇ}^{j ( ω t + ϕ )} \cdot {C}_{d} ( t ) ⅆ t & ( 2 ) \\ + 1 / T \int [ nT , ( n + 1 ) T ] {S}_{disturbances} ( t ) \cdot {ⅇ}^{j ( ω t + ϕ )} \cdot {C}_{d} ( t ) ⅆ t & ( 3 )\end{matrix}$$

$$( 1 ) = 1 / T \int [ nT , ( n + 1 ) T ] \cdot sin ( ω t ) \cdot {C}_{p} ( t ) \cdot {ⅇ}^{j ( ω t + ϕ )} \cdot {C}_{d} ( t ) ⅆ t \\ ( 2 ) = \begin{matrix}1 / T \int [ nT , ( n + 1 ) T ] \cdot cos ( ω t ) \cdot \\ {D}_{ent} ( t ) \cdot {C}_{d} ( t ) \cdot {ⅇ}^{j ( ω t + ϕ )} \cdot {C}_{d} ( t ) ⅆ t\end{matrix}$$

$$( 3 ) = noise$$

The term (1) is zero since the data Cd and pilot Cp codes are decorrelated. We finally obtain for z_{d}:
z_{d}(n)=½e^{jφ}Dₑₙₜ(nT+)+noise

We have thus eliminated for the data pathway, the modulation by the carrier and by the spreading code. By virtue of a carrier phase loop, the phase of the local carrier φ is slaved with respect to that of the carrier received, equal to 0. The modulation is finally preserved by the interleaved coded data Dent.

We obtain for zₚ:

$$\begin{matrix}{z}_{p} ( n ) = 1 / T \int [ nT , ( n + 1 ) T ] {S}_{p} ( t ) \cdot {ⅇ}^{j ( ω t + ϕ )} \cdot {C}_{p} ( t ) ⅆ t & ( 1 ) \\ + 1 / T \int [ nT , ( n + 1 ) T ] {S}_{d} ( t ) \cdot {ⅇ}^{j ( ω t + ϕ )} \cdot {C}_{p} ( t ) ⅆ t & ( 2 ) \\ + 1 / T \int [ nT , ( n + 1 ) T ] {S}_{disturbances} ( t ) \cdot {ⅇ}^{j ( ω t + ϕ )} \cdot {C}_{p} ( t ) ⅆ t & ( 3 )\end{matrix}$$

$$( 1 ) = 1 / T \int [ nT , ( n + 1 ) T ] \cdot sin ( ω t ) \cdot {C}_{p} ( t ) \cdot {ⅇ}^{j ( ω t + ϕ )} \cdot {C}_{p} ( t ) ⅆ t \\ ( 2 ) = \begin{matrix}1 / T \int [ nT , ( n + 1 ) T ] \cdot cos ( ω t ) \cdot \\ {D}_{ent} ( t ) \cdot {C}_{d} ( t ) \cdot {ⅇ}^{j ( ω t + ϕ )} \cdot {C}_{p} ( t ) ⅆ t\end{matrix}$$

$$( 3 ) = noise$$

The term (2) is zero since the data Cd and pilot Cp codes are decorrelated.

Concerning the term (1), we distinguish several cases according to the way in which the pilot code is constituted.

According to a first embodiment, the spreading code Cₚ(t) of the pilot pathway is the product of two codes, a primary code Cₚₚ(t) and a secondary code Cₛₚ(t) in particular for the following reason. The duration of acquisition of the received signal is proportional to the length of the code: when the code is the product of a primary code and a secondary code, the acquisition can be carried out on the basis of the primary code alone, thereby considerably reducing the acquisition duration, the secondary code being that used for the synchronization of the deinterleaving.

We recall that the acquisition consists in synchronizing the local code with the code received by an energy search: the receiver tests all the possible delays of the local code with respect to the received code (delays limited to the wavelength of the code), from half-code chip to half-code chip, until it obtains the correlation peak which appears when the local code and the received code are in phase and which is detected at the output of the integrators.

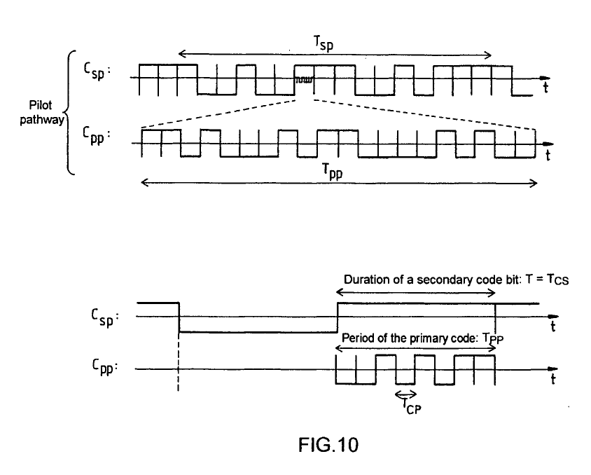

The primary code Cₚₚ(t) has a high frequency and a short length Tₚₚ and the secondary code Cₛₚ(t) has a frequency equal to the inverse of the length of the primary code and a length Tₛₚ which is a multiple of M or of M.N depending on whether the interleaving is convolutional or matrix. Represented in FIG. 10 is an exemplary primary code Cₚₚ(t) and secondary code Cₛₚ(t). In this case, on reception, the modulation by the primary code is eliminated for the pilot pathway, keeping only the modulation by the secondary code which is used for the synchronization of the deinterleaving.

We obtain by integrating over the duration of a secondary code bit:
(1)=1/T∫_{[nT, (n+1)T]} sin(ωt). Cₚₚ(t).Cₛₚ(t).e^{j(ω+φ)}.Cₚₚ(t)dt
zₚ(n)=½e^{j(φπ/2)}Cₛₚ(t)+noise

The modulation by the carrier and by the primary code have been eliminated this time for the pilot pathway. By virtue of a carrier phase loop, the phase of the local carrier φ is slaved with respect to that of the carrier received, equal to 0. The modulation by the secondary code Cₛₚ is finally preserved. It then suffices to recognize the secondary code sequence to determine which transition corresponds to the start of the periodic deinterleaving sequence. The synchronization of the deinterleaving is thus carried out after correlation by the primary code.

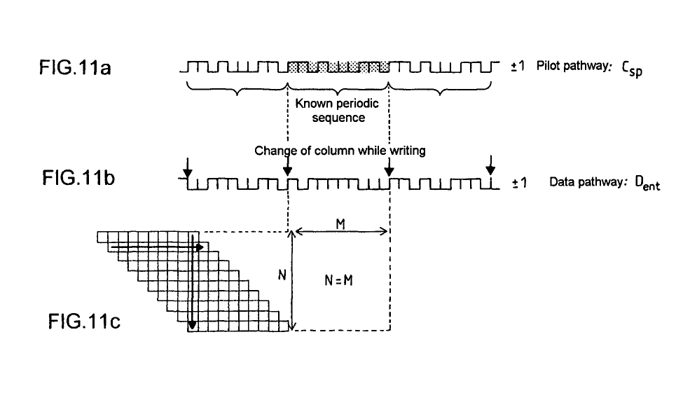

Represented in FIG. 11a is the pilot pathway signal in which are included the known periodic sequences also denoted code Cₛₚ(t) and represented in FIG. 11b are the interleaved symbols Dₑₙₜ of the data pathway, at the input of the deinterleaving device, that is to say ready to be written to this device in the form of columns. The changes of column during writing are also indicated. The table represented in FIG. 11c, is that of an exemplary convolutional deinterleaving, with N=M.

According to a variant of the invention, the spreading code Cₚ(t) of the pilot pathway is the product of three codes according to the same principle, a primary code, a secondary code and a tertiary code, the latter being used for the synchronization of the deinterleaving. The pilot primary code can be identical to the primary code of the data pathway, the pilot secondary code decorrelated from the secondary code of the data pathway, and the tertiary code a multiple of M or M.N depending on whether the interleaving is convolutional or matrix.

The introduction of these secondary or tertiary codes increases the period of the global code of the pilot pathway and therefore the spectral spreading of the jammer, thereby presenting the advantage of improving resistance to narrowband interference.

According to another embodiment, the receiver performs the acquisition by a first synchronization of the local primary code with the received signal, (with a correlation of the received signal with the primary code without correlation with the secondary code by integrating over the duration of a secondary code bit), then by a second synchronization of the local secondary code with the received signal (with a correlation of the received signal with the primary and secondary codes by integrating over a duration independent of the codes).

The second synchronization is obtained by an energy search: the receiver tests all the possible delays of the local secondary code with respect to the received secondary code (delays limited to the wavelength of the code), from chip to chip, until it obtains the correlation peak which appears when the local secondary code and the received secondary code are in phase and which is detected at the output of the integrators.

The primary and secondary local codes are then synchronous with the primary and secondary codes received. It is then immediately possible to know the moment at which the deinterleaving commences: the synchronization of the deinterleaving is carried out during the correlation by the secondary code.

According to another embodiment, the spreading code Cₚ(t) of the pilot pathway is not the product of two codes. In this case, by integrating over a duration independent of the codes, we obtain:
(1)=1/T∫_{[nT, (n+1)T]} sin(ωt).Cₚ(t).e^{j(ωtφ)}.Cₚ(t)dt
zₚ=½e^{j(φπ/2)}+noise

The modulation by the carrier and by the code Cₚ have been eliminated. By virtue of a carrier phase loop, the phase of the local carrier φ is slaved with respect to that of the carrier received, equal to 0. The local code is thus synchronous with the code received and it is then immediately possible to know the moment at which the deinterleaving commences: the synchronization of the deinterleaving is thus carried out during the correlation by the code Cp.

The deinterleaving is performed by means of a deinterleaving device Des to obtain the coded symbols D_{cod}(t) as already described in conjunction with FIG. 5. Likewise the coded symbols D_{cod}(t) obtained are decoded by means of a device for implementing the Viterbi algorithm, “FEC⁻¹” to obtain the data D(t).

The invention has been described in the case of a radionavigation signal transmitted by a satellite. It is possible to extend it to several satellites each transmitting a radionavigation signal on the same carrier.

In this case, the receiver comprises a reception channel per satellite, that is to say as many reception channels as radionavigation signals. For each reception channel receiving a signal such as described, the receiver comprises the elements such as those described in conjunction with FIG. 9.

Generally the radionavigation signal originates from one or more satellites. It may also originate from one or more pseudolites.

1. A method of transmitting a radionavigation signal having coded and interleaved data, comprising the steps of:
modulating a signal having a pathway by the coded and interleaved data and another pathway not modulated by the coded and interleaved data, and in that the pathway not modulated by these data has a known code Cp making it possible to synchronize on reception the deinterleaving of the interleaved data.

2. The method as claimed in claim 1, wherein the interleaving and the deinterleaving are obtained on the basis of a memory comprising rows and columns exhibiting respectively M and N memory slots.

3. The method as claimed in claim 1, wherein the interleaving is convolutional and N=M and in that the known code Cp exhibits a length which is a multiple of M.

4. The method as claimed in claim 2, wherein the interleaving is a matrix interleaving and the known code Cp exhibits a length which is a multiple of M.N.

5. The method as claimed in claim 1, wherein the data are coded by using an error correcting code.

6. The method as claimed in claim 1, wherein the error correcting code is an “FEC” code.

7. The method as claimed in claim 1, wherein the pathway modulated by the data is also modulated by a known spreading code Cd, the code Cd being decorrelated from the code Cp.

8. The method as claimed in claim 1, wherein the pathway not modulated by the data furthermore comprises a primary code Cpp, the known code Cp then being denoted secondary code Csp.

9. The method as claimed in claim 1, wherein the radionavigation signal is transmitted by a satellite or a pseudolite.

10. The method as claimed in claim 1, wherein the radionavigation signal is a GNSS signal.

11. A transmitter of a radionavigation signal, comprising:
a data generator,
a device for coding the data,
a device for interleaving the coded data,
a generator of code Cd intended to generate a signal modulated by the coded and interleaved data; and
a generator of code Cp decorrelated from the code Cd and intended to generate a signal not modulated by the data.

12. The transmitter as claimed in claim 11, wherein the interleaving device includes a memory which comprises rows and columns each exhibiting M memory slots and in that the generator of code Cp is intended to generate a code of length equal to a multiple of M.

13. The transmitter as claimed in claim 11, wherein the interleaving device includes a memory which comprises rows and columns exhibiting respectively M and N memory slots and in that the generator of code Cp is intended to generate a code of length equal to a multiple of M.N.

14. The transmitter as claimed in claim 11, wherein the device for coding the data is a device with error correcting code.

15. The transmitter as claimed in one of claim 11, wherein the radionavigation signal is a GNSS signal.

16. A receiver of at least one radionavigation signal including coded and interleaved data modulated by a code Cd, comprising:
a reception channel for each radionavigation signal, and comprising for at least one reception channel,
a generator of the code able to demodulate the radionavigation signal so as to obtain the coded and interleaved data,
a device for deinterleaving the coded data, wherein the reception channel has two pathways, the deinterleaving device is on a first pathway and,
a generator of another code Cp decorrelated from the code Cd, and intended to synchronize the deinterleaving device on the second pathway.

17. The receiver as claimed in claim 16 comprising on the first pathway a device for decoding the deinterleaved data.

18. The receiver as claimed in claim 17, wherein the decoding device is able to implement the Viterbi algorithm.

19. The receiver as claimed in of claim 16, wherein the deinterleaving device comprises a memory which comprises rows and columns exhibiting respectively M and N memory slots and in that the generator of code Cp is intended to generate a code of length equal to a multiple of M.N.

20. The receiver as claimed in claim 16, wherein the deinterleaving device comprises a memory which comprises rows and columns each exhibiting M memory slots and in that the generator of code Cp is intended to generate a code of length equal to a multiple of M.
